(19) United States
(12) Patent Application Publication
(10) Pub. No.: US 2025/0181608 A1
(43) Pub. Date: Jun. 5, 2025

(54) METHOD AND SYSTEM FOR AUTOMATED DATA CAPTURE AND MANAGEMENT

(71) Applicant: JPMorgan Chase Bank, N.A., New York, NY (US)

(72) Inventors: Aleksey MASLOV, New York, NY (US); Praveen REDDY, Secaucus, NJ (US); Daniel DEVERELL, Brooklyn, NY (US)

(73) Assignee: JPMorgan Chase Bank, N.A., New York, NY (US)

(21) Appl. No.: 18/524,786

(22) Filed: Nov. 30, 2023

(51) Int. Cl. G06F 16/28; G06F 16/25

(52) U.S. Cl. CPC G06F 16/287; G06F 16/258

(57) ABSTRACT

A method for facilitating automated data capture and management is disclosed. The method includes detecting an execution of a target application; initializing, based on a result of the detecting, a set of instructions that is associated with the target application; configuring an operational state for the target application based on the set of instructions; capturing, via the target application, user data based on the configured operational state, the user data including information that relates to interaction events between a user and the target application; validating, by using a predetermined data model, the captured user data to generate validated data sets; and classifying, by using the predetermined data model, the validated data sets to generate structured data sets.

### BACKGROUND

### 1. Field of the Disclosure

This technology generally relates to methods and systems for capturing and managing data, and more particularly to methods and systems for facilitating automated capture and automated management of data from instrumented digital property without manual addition of explicit software code.

### 2. Background Information

Many business entities operate large networks of digital properties such as, for example, applications that facilitate various business operations. Often, user behaviors may be captured for interactions between users and the applications. Historically, implementations of conventional techniques for capturing and managing data have resulted in varying degrees of success with respect to automating the collection and analysis of user behaviors to provide personalization, automated business workflow management, outlier detection, trend forecasting, and bespoke business offering.

One drawback of implementing the conventional techniques is that in many instances, explicit codes are required for each of the applications to facilitate the capture. As a result, resource intensive processes are required to capture, classify, and model the user behaviors in large application networks. Further, when user behavior events are recorded by using origination inheritance hierarchal models, the event capture and identification may become non-reusable and tightly coupled to the specific digital property, which negates reusability and flexibility to accommodate changes and/or additions to the instrumented digital property.

Similarly, manual code additions require Apriory knowledge of targeted outcomes instead of known conditions and/or actions, which are available in reports. Thus, manual code additions are not effective solutions for discovering “unknown unknowns” such as, for example, for discovering attempts at malevolent usage and for discovering attack or abuse of software/website. Additionally, each individual implementation of the explicit codes is forced to define a bespoke data model due to a lack of an available common data model.

Therefore, there is a need to alleviate the requirement for resource intensive addition of explicit codes to facilitate the automated collection and analysis of user behaviors to provide personalization, trend forecasting, and bespoke business offering. Moreover, the automated collection and analysis of user behaviors may be leveraged to monitor digital properties in real-time to identify and alleviate attacks by automatically stopping suspicious traffic, trapping suspected attackers, as well as isolating in progress attacks of vital assets and applications.

### SUMMARY

The present disclosure, through one or more of its various aspects, embodiments, and/or specific features or sub-components, provides, inter alia, various systems, servers, devices, methods, media, programs, and platforms for facilitating automated capture and automated management of data from instrumented digital property without manual addition of explicit software code.

According to an aspect of the present disclosure, a method for facilitating automated data capture and management is disclosed. The method is implemented by at least one processor. The method may include detecting an execution of at least one target application; initializing, based on a result of the detecting, at least one set of instructions that is associated with the at least one target application; configuring an operational state for the at least one target application based on the initialized at least one set of instructions; capturing, via the at least one target application, user data based on the configured operational state, the user data may include information that relates to at least one interaction event between a user and the at least one target application; validating, by using a predetermined data model, the captured user data to generate at least one validated data set; and classifying, by using the predetermined data model, the at least one validated data set to generate at least one structured data set.

In accordance with an exemplary embodiment, the method may further include determining a user journey funnel that corresponds to the user based on the at least one structured data set, the user journey funnel may include contextual information that is related to the at least one interaction event.

In accordance with an exemplary embodiment, the method may further include determining, by using at least one predictive model, at least one predictive output based on the at least one structured data set and the user journey funnel, the at least one predictive output may include an adjustment action that alters at least one functionality of the at least one target application.

In accordance with an exemplary embodiment, the method may further include generating at least one graphical element for the at least one structured data set; and displaying, via a graphical user interface, the generated at least one graphical element, the at least one graphical element may include a visual representation of at least one from among the at least one structured data set, the user journey funnel, and the at least one predictive output.

In accordance with an exemplary embodiment, the at least one predictive model may include at least one from among a large language model, a deep learning model, a neural network model, a natural language processing model, a machine learning model, a mathematical model, and a process model.

In accordance with an exemplary embodiment, the at least one set of instructions may correspond to a software development kit that includes a collection of software development tools in at least one installable data package, the software development kit may include at least one software library.

In accordance with an exemplary embodiment, the at least one set of instructions may include at least one from among a configuration parameter, a service uniform resource locator, and a listing of allowed network connections.

In accordance with an exemplary embodiment, the initializing may include at least one from among a build-time initializing process when source code of the at least one target application is accessible and a runtime initializing process when the source code of the at least one target application is not accessible.

In accordance with an exemplary embodiment, to generate the at least one structured data set, the method may further include identifying at least one downstream application that is associated with the at least one target application; determining at least one data format requirement for the identified at least one downstream application; and formatting the at least one structured data set based on the determined at least one data format requirement.

According to an aspect of the present disclosure, a computing device configured to implement an execution of a method for facilitating automated data capture and management is disclosed. The computing device including a processor; a memory; and a communication interface coupled to each of the processor and the memory, wherein the processor may be configured to detect an execution of at least one target application; initialize, based on a result of the detecting, at least one set of instructions that is associated with the at least one target application; configure an operational state for the at least one target application based on the initialized at least one set of instructions; capture, via the at least one target application, user data based on the configured operational state, the user data may include information that relates to at least one interaction event between a user and the at least one target application; validate, by using a predetermined data model, the captured user data to generate at least one validated data set; and classify, by using the predetermined data model, the at least one validated data set to generate at least one structured data set.

In accordance with an exemplary embodiment, the processor may be further configured to determine a user journey funnel that corresponds to the user based on the at least one structured data set, the user journey funnel may include contextual information that is related to the at least one interaction event.

In accordance with an exemplary embodiment, the processor may be further configured to determine, by using at least one predictive model, at least one predictive output based on the at least one structured data set and the user journey funnel, the at least one predictive output may include an adjustment action that alters at least one functionality of the at least one target application.

In accordance with an exemplary embodiment, the processor may be further configured to generate at least one graphical element for the at least one structured data set; and display, via a graphical user interface, the generated at least one graphical element, the at least one graphical element may include a visual representation of at least one from among the at least one structured data set, the user journey funnel, and the at least one predictive output.

In accordance with an exemplary embodiment, the at least one predictive model may include at least one from among a large language model, a deep learning model, a neural network model, a natural language processing model, a machine learning model, a mathematical model, and a process model.

In accordance with an exemplary embodiment, the at least one set of instructions may correspond to a software development kit that includes a collection of software development tools in at least one installable data package, the software development kit may include at least one software library.

In accordance with an exemplary embodiment, the at least one set of instructions may include at least one from among a configuration parameter, a service uniform resource locator, and a listing of allowed network connections.

In accordance with an exemplary embodiment, the initializing may include at least one from among a build-time initializing process when source code of the at least one target application is accessible and a runtime initializing process when the source code of the at least one target application is not accessible.

In accordance with an exemplary embodiment, to generate the at least one structured data set, the processor may be further configured to identify at least one downstream application that is associated with the at least one target application; determine at least one data format requirement for the identified at least one downstream application; and format the at least one structured data set based on the determined at least one data format requirement.

According to an aspect of the present disclosure, a non-transitory computer readable storage medium storing instructions for facilitating automated data capture and management is disclosed. The storage medium including executable code which, when executed by a processor, may cause the processor to detect an execution of at least one target application; initialize, based on a result of the detecting, at least one set of instructions that is associated with the at least one target application; configure an operational state for the at least one target application based on the initialized at least one set of instructions; capture, via the at least one target application, user data based on the configured operational state, the user data may include information that relates to at least one interaction event between a user and the at least one target application; validate, by using a predetermined data model, the captured user data to generate at least one validated data set; and classify, by using the predetermined data model, the at least one validated data set to generate at least one structured data set.

In accordance with an exemplary embodiment, when executed by the processor, the executable code may further cause the processor to determine a user journey funnel that corresponds to the user based on the at least one structured data set, the user journey funnel may include contextual information that is related to the at least one interaction event.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated capture and automated management of data from instrumented digital property without manual addition of explicit software code.

FIG. 4 is a flowchart of an exemplary process for implementing a method for facilitating automated capture and automated management of data from instrumented digital property without manual addition of explicit software code.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

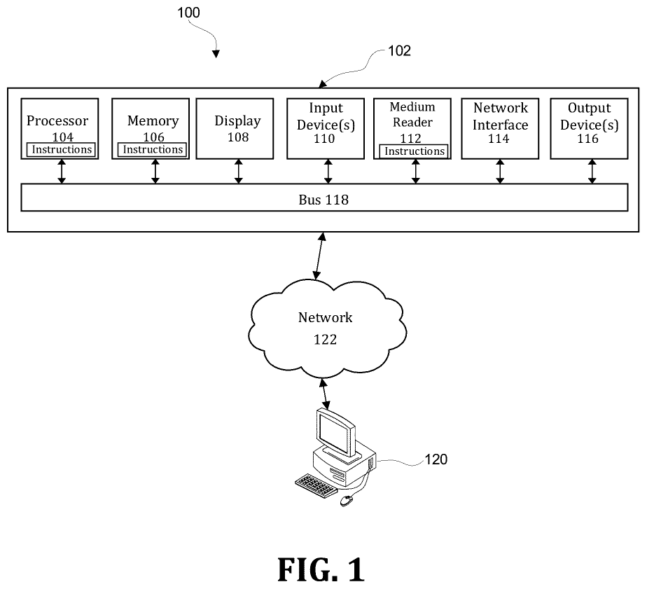

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated capture and automated management of data from instrumented digital property without manual addition of explicit software code.

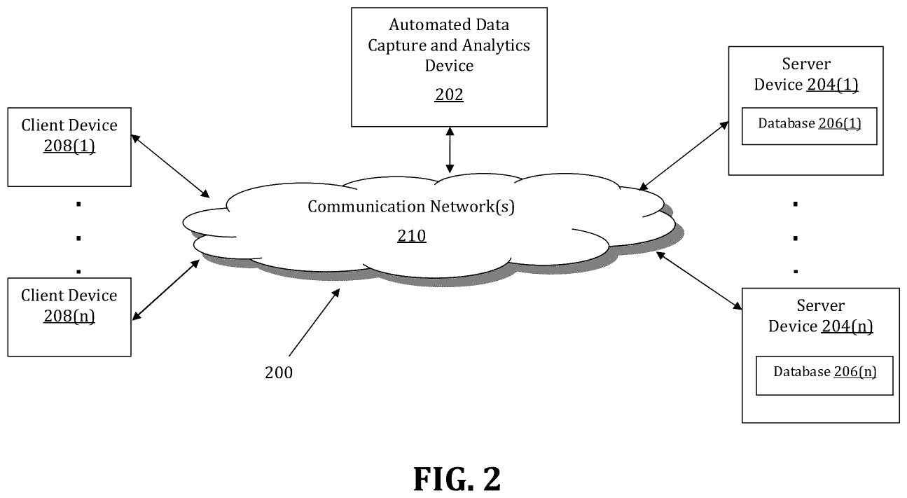

Referring to FIG. 2, a schematic of an exemplary network environment 200 for implementing a method for facilitating automated capture and automated management of data from instrumented digital property without manual addition of explicit software code is illustrated. In an exemplary embodiment, the method is executable on any networked computer platform, such as, for example, a personal computer (PC).

The method for facilitating automated capture and automated management of data from instrumented digital property without manual addition of explicit software code may be implemented by an Automated Data Capture and Analytics (ADCA) device 202. The ADCA device 202 may be the same or similar to the computer system 102 as described with respect to FIG. 1. The ADCA device 202 may store one or more applications that can include executable instructions that, when executed by the ADCA device 202, cause the ADCA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADCA device 202 itself, may be located in virtual server(s) running in a cloud-based computing environment rather than being tied to one or more specific physical network computing devices. Also, the application(s) may be running in one or more virtual machines (VMs) executing on the ADCA device 202. Additionally, in one or more embodiments of this technology, virtual machine(s) running on the ADCA device 202 may be managed or supervised by a hypervisor.

In the network environment 200 of FIG. 2, the ADCA device 202 is coupled to a plurality of server devices 204(1)-204(n) that hosts a plurality of databases 206(1)-206(n), and also to a plurality of client devices 208(1)-208(n) via communication network(s) 210. A communication interface of the ADCA device 202, such as the network interface 114 of the computer system 102 of FIG. 1, operatively couples and communicates between the ADCA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADCA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ADCA devices that efficiently implement a method for facilitating automated capture and automated management of data from instrumented digital property without manual addition of explicit software code.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADCA device 202 may be a standalone device or integrated with one or more other devices or apparatuses, such as one or more of the server devices 204(1)-204(n), for example. In one particular example, the ADCA device 202 may include or be hosted by one of the server devices 204(1)-204(n), and other arrangements are also possible. Moreover, one or more of the devices of the ADCA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADCA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user behavior data, application data, sets of instructions, software development kits, interaction events, validated data sets, structured data sets, and user journey funnels.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ADCA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ADCA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ADCA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ADCA device 202, the server devices 204(1)-204(n), or the client devices 208(1)-208(n), for example, may be configured to operate as virtual instances on the same physical machine. In other words, one or more of the ADCA device 202, the server devices 204(1)-204(n), or the client devices 208(1)-208(n) may operate on the same physical device rather than as separate devices communicating through communication network(s) 210. Additionally, there may be more or fewer ADCA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

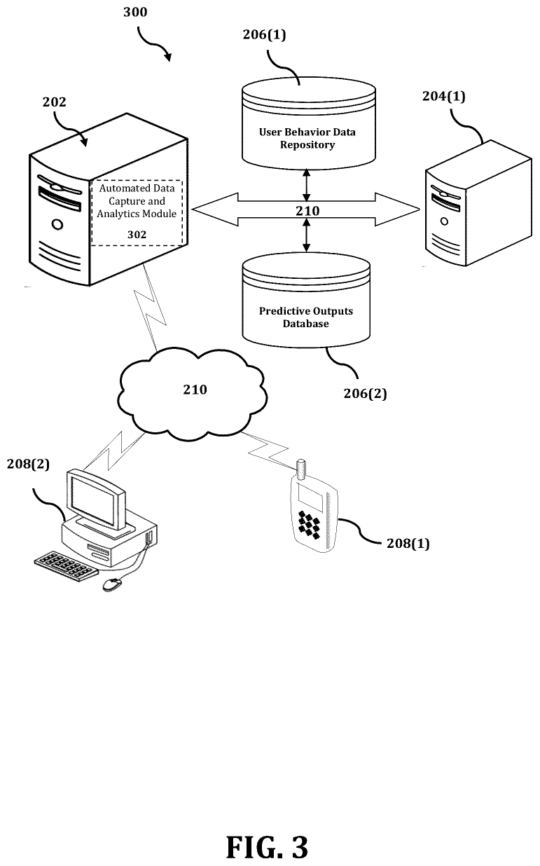

The ADCA device 202 is described and shown in FIG. 3 as including an automated data capture and analytics module 302, although it may include other rules, policies, modules, databases, or applications, for example. As will be described below, the automated data capture and analytics module 302 is configured to implement a method for facilitating automated capture and automated management of data from instrumented digital property without manual addition of explicit software code.

An exemplary process 300 for implementing a mechanism for facilitating automated capture and automated management of data from instrumented digital property without manual addition of explicit software code by utilizing the network environment of FIG. 2 is shown as being executed in FIG. 3. Specifically, a first client device 208(1) and a second client device 208(2) are illustrated as being in communication with ADCA device 202. In this regard, the first client device 208(1) and the second client device 208(2) may be “clients” of the ADCA device 202 and are described herein as such. Nevertheless, it is to be known and understood that the first client device 208(1) and/or the second client device 208(2) need not necessarily be “clients” of the ADCA device 202, or any entity described in association therewith herein. Any additional or alternative relationship may exist between either or both of the first client device 208(1) and the second client device 208(2) and the ADCA device 202, or no relationship may exist.

Further, ADCA device 202 is illustrated as being able to access a user behavior data repository 206(1) and a predictive outputs database 206(2). The automated data capture and analytics module 302 may be configured to access these databases for implementing a method for facilitating automated capture and automated management of data from instrumented digital property without manual addition of explicit software code.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ADCA device 202 via broadband or cellular communication. Of course, these embodiments are merely exemplary and are not limiting or exhaustive.

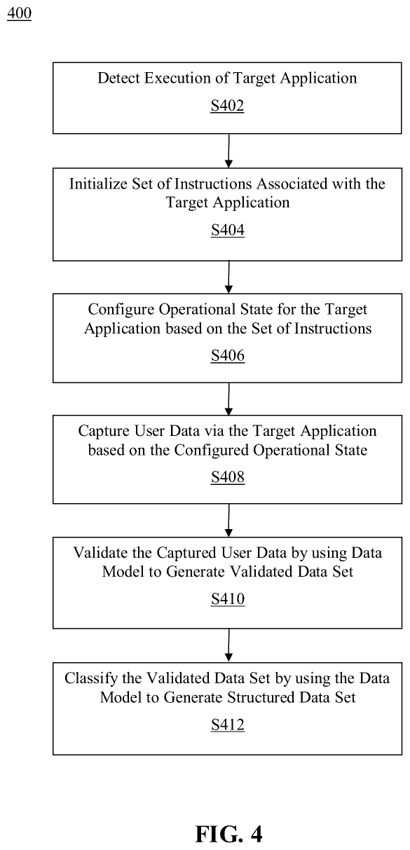

Upon being started, the automated data capture and analytics module 302 executes a process for facilitating automated capture and automated management of data from instrumented digital property without manual addition of explicit software code. An exemplary process for facilitating automated capture and automated management of data from instrumented digital property without manual addition of explicit software code is generally indicated at flowchart 400 in FIG. 4.

In the process 400 of FIG. 4, at step S402, execution of a target application may be detected. In an exemplary embodiment, the execution may be detected by using software packages such as, for example, software development kits (SDK) that have been installed on the target application. The software packages may include a set of tools that is usable to build software programs such as, for example, the target application. The set of tools may be prebuilt with functionalities such as, for example, the functionalities described in the present disclosure to facilitate the capture and management of user behavior data via the target application.

In another exemplary embodiment, the software packages may be installed on the target application by using at least one from among a build-time installation process and a runtime installation process. The build-time installation process may be usable when access to a codebase of the target application is available. The build-time installation process may include software code such as, for example, an installation package manager that is implemented during a development pipeline of the target application such as, for example, during the deployment pipeline to facilitate the installation.

Alternatively, the runtime installation process may be usable when access to the codebase of the target application is not available. The runtime installation process may also be usable when an application team that is associated with the target application cannot include the software packages as modules to the target application. The runtime installation process may include software code such as, for example, an activation script that is implemented to execute the software packages during execution of the target application.

In another exemplary embodiment, the target application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, a set of instructions that is associated with the target application may be initialized based on a result of the detection. The set of instructions may be initialized when execution of the target application is detected. In an exemplary embodiment, consistent with present disclosures, the set of instructions may correspond to the software development kit that is installed in the target application. The set of instructions may include a collection of software development tools in an installable data package such as, for example, a corresponding software library that facilitates the initialized actions.

In another exemplary embodiment, the set of instructions may include at least one from among a configuration parameter, a service uniform resource locator, and a listing of allowed network connections. The configuration parameter may initialize a common state that will be shared among internal operations for the duration of the execution of the set of instructions. For example, the configuration parameter may specify an execution environment, initiate execution channels, as well as specify a type of authentication that the target application is using.

Further, the service uniform resource locator may relate to a data-collection service locator that is usable to call required application programming interfaces. The application programming interfaces may be called to facilitate communication and actions such as, for example, data-collection actions between various computing components. The service uniform resource locator may define an endpoint with parameters such as, for example, a domain, a port, a path, and/or a query string. Similarly, the listing of allowed network connections may be used when the target application is designed to screen its network connectivity. By defining allowed connections in the listing, the target application may not inadvertently block a desired connection path.

In another exemplary embodiment, the initializing may include at least one from among a build-time initializing process when source code of the at least one target application is accessible and a runtime initializing process when the source code of the at least one target application is not accessible. Consistent with present disclosures, the initializing options are a continuation of the installation processes. For example, when the build-time installation process is implemented, the set of instructions may be initialized with valid configuration parameters that correspond to the build-time initializing process. Alternatively, when the runtime installation process is implemented, the set of instructions may be initialized in a dynamic runtime environment that correspond to the runtime initializing process.

At step S406, an operational state for the target application may be configured based on the initialized set of instructions. In an exemplary embodiment, the set of instructions may operate as a stateful module within the full life cycle of the target application. The set of instructions may be initialized at the start of the target application execution process and remain active until the final steps in the target application execution process. Consistent with present disclosures, the configuration parameter may initialize a common state that will be shared among internal operations for the duration of the execution of the set of instructions. The configuration parameter may specify an execution environment, initiate execution channels, as well as specify a type of authentication that the target application is using.

In another exemplary embodiment, the operational state for the target application may be configured to capture custom context such as, for example, custom business context. Instrumented elements such as, for example, hyper-text markup language (HTML) elements may be customized with bespoke business context to facilitate the data capture. Similarly, the operational state for the target application may be configured to capture non-default browser events. The browser events may be generally categorized into three categories that include a capture by default category, a do not capture by default but may be instructed to capture category, and a backlisted category that is not captured irrespective of configuration.

At step S408, user data may be captured via the target application based on the configured operational state. In an exemplary embodiment, the user data may include information that relates to at least one interaction event between a user and the target application. For example, the user data may describe an interaction between the user and the target application to facilitate a user account creation workflow. The information may include user behavior information that is captured to provide analytics, personalization, trend forecasting, and bespoke business offerings. For example, the user behavior information may include a length of time necessary to complete the user account creation workflow via the target application.

At step S410, the captured user data may be validated by using a predetermined data model to generate validated data sets. In an exemplary embodiment, the predetermined data model may relate to a common data model that has been defined to provide consistent data structuring and formatting. The predetermined data model may be usable to validate captured user data to ensure the quality of the user behavior data. For example, the predetermined data model may define account numbers as a series of alphanumeric characters. As such, the predetermined data model may be usable to remove data in an account data field that do not meet the defined criteria for the account numbers.

In another exemplary embodiment, in case of bespoke business context that uses various predictive and mathematical models, the disclosed system may be capable of automatically discovering outliers. The outliers may relate to data points that are inconsistent with other data points across the various predictive and mathematical models. Additionally, the disclosed system may discover directional trends in the captured business context across the various predictive and mathematical models. The disclosed system may discover outliers and/or discover directional trends in the captured business context without using a predetermined data model.

In another exemplary embodiment, the discovery of outliers and/or discovery of directional trends may facilitate identification of malevolent user inputs and behavior. This identification may be facilitated both historically based on stored data as well as in real-time based on captured data. The disclosed system may identify incoming traffic with malevolent user inputs and/or data for additional pattern and threat analysis. The disclosed system may also dynamically respond to in-progress attacks by isolating malevolent traffic away from legitimate business use cases. For example, the disclosed system may discover traffic outliers that are malevolent by utilizing user behavior analysis and then set up corresponding honeypot traps for the malevolent traffic.

At step S412, the validated data sets may be classified by using the predetermined data model to generate structured data sets. In an exemplary embodiment, the predetermined data model may relate to a common data model that has been defined to provide consistent data structuring and formatting. The predetermined data model may be usable to classify captured user data to ensure identification of data elements within the user behavior data. For example, the predetermined data model may define an account number as containing a series of seven numbers. This definition may be usable to tag data elements in the user behavior data with seven numbers as account numbers.

In another exemplary embodiment, predictive models such as, for example, machine learning models and artificial intelligence models may be usable to classify the validated data consistent with present disclosures. By using the predictive models, the disclosed system may be able to automatically discover and label context and business knowledge that have been previously captured. The validated data sets may be classified by using the predictive models described in the present disclosure to generate the structured data sets.

In another exemplary embodiment, the classified data in the structured data sets may facilitate contextual filtering actions such as, for example, the filtering of useful events from non-action events. The classified data in the structured data sets may be categorized according to corresponding classifications based on the predetermined data model. Consistent with present disclosures, the contextual filtering actions and the categorizing actions may be accomplished automatically without additional input.

In another exemplary embodiment, to facilitate the generating of the structured data sets, downstream applications that are associated with the target application may be identified. The downstream applications may be identified based on a network mapping of an application network such as, for example, a choreography mapping of microservice applications. Alternatively, the downstream applications may be automatically determined based on information from the target application such as, for example, destination information related to a published event message.

Then, data format requirements for the identified downstream applications may be determined. The data format requirements may define a required data type that is acceptable by the downstream applications. The data format requirements may provide structural data requirements for use with the downstream applications. For example, the data format requirements may indicate a need for data cleaning for use of the captured data in downstream machine learning models and/or artificial intelligence models. The structured data set may be formatted based on the determined data format requirement prior to transmission to the downstream applications.

In another exemplary embodiment, the disclosed invention may be usable to generate a user journey funnel for the user. The user journey funnel may be automatically generated by using the validated and classified information without requiring additional input. To facilitate the generation, the user journey funnel that corresponds to the user may be determined based on the structured data sets that are associated with the user. The user journey funnel may include contextual information that is related to the interaction events between the user and the target application.

In another exemplary embodiment, the automatic generation of the user journey funnel may be facilitated by automated tracking of users such as, for example, site visitors consistent with present disclosures. The users may be automatically tracked across all applications that have been previously onboarded. That is, a particular user is not merely tracked across devices, but rather, the particular user may be tracked on the same device across otherwise disjointed digital properties. For example, customers of a business entity may be tracked, per device and per browser, across all participating digital properties as a unified customer journey of that business entity.

The unified customer journey may relate to a meta-journey, which encompasses application-scope user journey analytics consistent with present disclosures. As such, an entity-level journey may be generated, which consists of one or more within application journeys. The unified customer journey may enable performance of cross digital property analytics and/or unified multitenant digital property analytics. The tracking may be accomplished automatically without addition of any extra code into the corresponding applications other than previously incorporated developer building tools such as, for example, the SDK.

In another exemplary embodiment, the user journey funnel may include at least one from among a user journey mapping and a user funnel mapping. The user journey mapping of event data may provide information related to user interest. The user journey mapping may track individual touchpoints in the target application to gauge interest in particular products and/or services. For example, the user journey mapping may provide user interest information for a website by tracking intentional interactions on the website.

Alternatively, the user funnel mapping of event data may provide information related to user experience with the target application. The user funnel mapping may track user activities as tasks are completed via the target application. The user activities may provide insight onto how the target application is used by the user. For example, the user funnel mapping may help to identify areas of friction in a workflow that needs improvement, as well as enable data-driven decision-making that optimizes the user experience.

In another exemplary embodiment, predictive outputs may be determined based on the structured data set and the user journey funnel. The predictive outputs may be automatically determined by using a predictive model that processes the structured data set and the user journey funnel. The predictive model may be usable to identify patterns that provide additional insights onto user behaviors to provide recourse for the target application. The predictive output may include recommended adjustment actions that alter functionalities of the target application. The adjustment actions may be recommended for the target application to prevent a potential issue and/or improve user experience. For example, the predictive outputs may include adjustment actions for the target application to reduce current and/or potential user friction.

In another exemplary embodiment, the disclosed system may be integrated with various functions such as, for example, cost functions as well as profit and loss functions. When integrated with these functions, the disclosed system may be capable of automatically analyzing parameters such as, for example, costs of empirical customer behavior based on a corresponding user journey funnel. Consistent with present disclosures, the predictive model may be usable to determine predictive outputs such as, for example, providing optimization recommendations based on the automatically analyzed parameters.

In another exemplary embodiment, the predictive model may include at least one from among a large language model, a deep learning model, a neural network model, a natural language processing model, a machine learning model, a mathematical model, and a process model. The language model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, support vector machine (SVM) analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

In another exemplary embodiment, graphical elements may be generated for the structured data set. The graphical elements may correspond to a visual representation that is generated to provide information related to the structured data set. The graphical elements may include the visual representation of at least one from among the structured data set, the user journey funnel, and the predictive output. The graphical elements may also include graphical components such as, for example, icons, buttons, and menus that facilitate interactions with the provided information. For example, an administrator may interact with the graphical components on the graphical element to view additional information related to the user journey funnel of the user. The generated graphical elements may be displayed via a graphical user interface.

Accordingly, with this technology, an optimized process for facilitating automated capture and automated management of data from instrumented digital property without manual addition of explicit software code is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated data capture and management, the method being implemented by at least one processor, the method comprising:
detecting, by the at least one processor, an execution of at least one target application;
initializing, by the at least one processor based on a result of the detecting, at least one set of instructions that is associated with the at least one target application;
configuring, by the at least one processor, an operational state for the at least one target application based on the initialized at least one set of instructions;
capturing, by the at least one processor via the at least one target application, user data based on the configured operational state, the user data including information that relates to at least one interaction event between a user and the at least one target application;
validating, by the at least one processor using a predetermined data model, the captured user data to generate at least one validated data set; and
classifying, by the at least one processor using the predetermined data model, the at least one validated data set to generate at least one structured data set.

2. The method of claim 1, further comprising:
determining, by the at least one processor, a user journey funnel that corresponds to the user based on the at least one structured data set,
wherein the user journey funnel includes contextual information that is related to the at least one interaction event.

3. The method of claim 2, further comprising:
determining, by the at least one processor using at least one predictive model, at least one predictive output based on the at least one structured data set and the user journey funnel,
wherein the at least one predictive output includes an adjustment action that alters at least one functionality of the at least one target application.

4. The method of claim 3, further comprising:
generating, by the at least one processor, at least one graphical element for the at least one structured data set; and
displaying, by the at least one processor via a graphical user interface, the generated at least one graphical element,
wherein the at least one graphical element includes a visual representation of at least one from among the at least one structured data set, the user journey funnel, and the at least one predictive output.

5. The method of claim 3, wherein the at least one predictive model includes at least one from among a large language model, a deep learning model, a neural network model, a natural language processing model, a machine learning model, a mathematical model, and a process model.

6. The method of claim 1, wherein the at least one set of instructions corresponds to a software development kit that includes a collection of software development tools in at least one installable data package, the software development kit including at least one software library.

7. The method of claim 1, wherein the at least one set of instructions includes at least one from among a configuration parameter, a service uniform resource locator, and a listing of allowed network connections.

8. The method of claim 1, wherein the initializing includes at least one from among a build-time initializing process when source code of the at least one target application is accessible and a runtime initializing process when the source code of the at least one target application is not accessible.

9. The method of claim 1, wherein the generating of the at least one structured data set further comprises:
identifying, by the at least one processor, at least one downstream application that is associated with the at least one target application;
determining, by the at least one processor, at least one data format requirement for the identified at least one downstream application; and
formatting, by the at least one processor, the at least one structured data set based on the determined at least one data format requirement.

10. A computing device configured to implement an execution of a method for facilitating automated data capture and management, the computing device comprising:
a processor;
a memory; and
a communication interface coupled to each of the processor and the memory,
wherein the processor is configured to:
detect an execution of at least one target application;
initialize, based on a result of the detecting, at least one set of instructions that is associated with the at least one target application;
configure an operational state for the at least one target application based on the initialized at least one set of instructions;
capture, via the at least one target application, user data based on the configured operational state, the user data including information that relates to at least one interaction event between a user and the at least one target application;
validate, by using a predetermined data model, the captured user data to generate at least one validated data set; and
classify, by using the predetermined data model, the at least one validated data set to generate at least one structured data set.

11. The computing device of claim 10, wherein the processor is further configured to:
determine a user journey funnel that corresponds to the user based on the at least one structured data set,
wherein the user journey funnel includes contextual information that is related to the at least one interaction event.

12. The computing device of claim 11, wherein the processor is further configured to:
determine, by using at least one predictive model, at least one predictive output based on the at least one structured data set and the user journey funnel,
wherein the at least one predictive output includes an adjustment action that alters at least one functionality of the at least one target application.

13. The computing device of claim 12, wherein the processor is further configured to:
generate at least one graphical element for the at least one structured data set; and
display, via a graphical user interface, the generated at least one graphical element,
wherein the at least one graphical element includes a visual representation of at least one from among the at least one structured data set, the user journey funnel, and the at least one predictive output.

14. The computing device of claim 12, wherein the at least one predictive model includes at least one from among a large language model, a deep learning model, a neural network model, a natural language processing model, a machine learning model, a mathematical model, and a process model.

15. The computing device of claim 10, wherein the at least one set of instructions corresponds to a software development kit that includes a collection of software development tools in at least one installable data package, the software development kit including at least one software library.

16. The computing device of claim 10, wherein the at least one set of instructions includes at least one from among a configuration parameter, a service uniform resource locator, and a listing of allowed network connections.

17. The computing device of claim 10, wherein the initializing includes at least one from among a build-time initializing process when source code of the at least one target application is accessible and a runtime initializing process when the source code of the at least one target application is not accessible.

18. The computing device of claim 10, wherein, to generate the at least one structured data set, the processor is further configured to:
identify at least one downstream application that is associated with the at least one target application;
determine at least one data format requirement for the identified at least one downstream application; and
format the at least one structured data set based on the determined at least one data format requirement.

19. A non-transitory computer readable storage medium storing instructions for facilitating automated data capture and management, the storage medium comprising executable code which, when executed by a processor, causes the processor to:
detect an execution of at least one target application;
initialize, based on a result of the detecting, at least one set of instructions that is associated with the at least one target application;
configure an operational state for the at least one target application based on the initialized at least one set of instructions;
capture, via the at least one target application, user data based on the configured operational state, the user data including information that relates to at least one interaction event between a user and the at least one target application;
validate, by using a predetermined data model, the captured user data to generate at least one validated data set; and
classify, by using the predetermined data model, the at least one validated data set to generate at least one structured data set.

20. The storage medium of claim 19, wherein, when executed by the processor, the executable code further causes the processor to:
determine a user journey funnel that corresponds to the user based on the at least one structured data set,
wherein the user journey funnel includes contextual information that is related to the at least one interaction event.
